(19) United States
(12) Patent Application Publication
(10) Pub. No.: US 2005/0163063 A1
(43) Pub. Date: Jul. 28, 2005

(54) Configuration and method for bidirectional transmission of signals in a motor vehicle

(75) Inventors: Gregor Kuchler, Thalmassing (DE); Peter Turban, Maxhutte-Haidhof (DE); Dieter Wagner, Laaber (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 11/046,172

(22) Filed: Jan. 28, 2005

(30) Foreign Application Priority Data
Jan. 28, 2004 (DE) 10 2004 004 292.6

(51) Int. Cl. H04B 7/005

(52) U.S. Cl. 370/278; 370/282

(57) ABSTRACT

A method for operating a tire pressure measuring system uses a transceiver. When triggered, the transceiver transmits an energy signal to a transponder in a tire that then responds with a data signal. So that the energy signals do not interfere with other transceivers on receipt of the data signals, the method makes provision for the repetition rate with which the energy signals are triggered to be a function of the speed of the vehicle. Transmission is more frequent at higher speed than at lower speed.

### BACKGROUND OF THE INVENTION

Field of the Invention

The invention relates to a configuration and a method for bidirectional transmission of signals in a motor vehicle, with receipt of a request signal triggering a response signal with data information.

Such a configuration is known for example from U.S. Pat. No. 6,581,449 B1. The patent describes a warning system, in which the tire pressure in each tire is monitored and an indication is given if the pressure is too low.

Such a system features a transmitter-receiver pair (referred to hereafter as a transceiver) that is assigned to a wheel of the vehicle in each case. A receiver-transmitter pair (referred to below as a transponder) is disposed in each tire. The transmitter of the transceiver first sends an energy signal on activation. The signal causes the transponder to return current tire parameters of the relevant tire to the vehicle.

In this case the transceiver transmits over a relatively long period a field with high field strength (high energy) so that the transponder is supplied with sufficient energy (charge phase). Then, when sufficient energy is stored in the transponder, the transceiver switches its field off and goes into receive mode (receive phase). The transponder uses the energy to generate tire and tire pressure data that is sent modulated as a data signal back to the transceiver.

If such systems for transmission of energy and/or data in the same transmission channel are used a number of times in the vehicle, signals with a high field strength can disturb the reception of data signals if both signals are present almost concurrently. If other vehicles are in the vicinity in which such a transmission system is already in operation and is operating in the same frequency range (transmission channel), the high field strengths can also disturb the reception of the data signals if the strong fields also exhibit an amplitude which is within the sensitivity range of the receiver at the time at which the data is received at the receiver location.

To reduce the likelihood of such disturbances the tire pressure could for example be requested less frequently. However it is desirable for pressure and temperature to be measured relatively frequently to obtain a response as soon as possible if the status of a tire changes.

Various methods are known from the prior art relating to how interference between a number of transmitters which belong to a receiver can be avoided. Many of these methods envision having the available transmitters transmitting at different times in order to avoid interference (faults) between the transmission of two transmitters and receivers. To this end for example random numbers (see Published Japanese Patent Application JP 2002/135274) or deterministic values (U.S. Pat. No. 6,507,276) are used in order to define different transmission times for the individual energy transmitters in each case. Any interferences or collisions which might still occur do not lead to loss of data if the transmission is repeated a number of times (U.S. Pat. No. 6,408,690). Basically the transmissions of different transmitters are distinguished using global identification signals assigned only once (see Published European Patent Application EP 1,043,179 A2).

With these known methods however the disturbances can hardly be avoided since the energy supply for passive transponders takes up a relatively large amount of time and the interrogation frequency is relatively high. For example, the signals with high field strength would have to be present for a relatively long period. It is thus highly likely that these signals will cause a disturbance. In addition these methods take no account of the signals being disturbed by other vehicles with identical systems.

### SUMMARY OF THE INVENTION

It is accordingly an object of the invention to provide a configuration and a method for bidirectional transmission of signals in a motor vehicle that overcome the above-mentioned disadvantages of the prior art devices and methods of this general type, in which a transmission of energy and data in a motor vehicle occurs and the receipt of data signals is disturbed as little as possible by external electromagnetic fields.

With the foregoing and other objects in view there is provided, in accordance with the invention, a configuration for bidirectional and wireless transmission of signals in a motor vehicle. The configuration contains a control unit, a first transmitter which, when triggered by the control unit, transmits a request signal, and a first receiver disposed remotely from the first transmitter, which, as a result of receipt of the request signal initiates preparation and transmission of a response signal. A second transmitter is connected to the first receiver and transmits the response signal. A second receiver is disposed remotely from the second transmitter and receives the response signal and forwards the response signal to the control unit for evaluation. A data line is connected to the control unit. A speed generator is coupled via the data line to the control unit, a triggering of the request signal being a function of the speed of the motor vehicle and the request signal being triggered more frequently at high speeds than at low speeds. The first transmitter is an energy transmitter, and on triggering transmits energy in an energy signal. The second receiver is a data receiver. The energy transmitter with the data receiver forms a transceiver assigned to a wheel in each case. The first receiver is disposed remotely from the transceiver and the second transmitter is connected to the first receiver forming a transponder having an energy store for buffering the energy received. The transponder is disposed in a tire of the motor vehicle in each case.

In this case the repetition rate of the transmission of a first signal is triggered by a transmitter of a transceiver as a function of the speed of the vehicle. A passive transponder prepares data after receiving the signal and transmits the data modulated back to the transceiver. As a result the return of the data is also correlated with the speed of the vehicle. The transceiver receives the speed information from a speed generator that is connected to the transceiver directly via a data line or indirectly via a control unit. As a result the signals can be transmitted more often when the speed is higher and less often at lower speed. This is because at high speed the distance to other vehicles is much greater than at low speed or when the vehicle is stationary. It is thus less likely that external energy transmitters are anywhere near the vehicle. Therefore the likelihood of a data transmission error is also less.

It is advantageous to use such a configuration and such a method in a tire pressure measuring system. The pressure sensors in the tires can then be interrogated more frequently at higher speeds. This is because it is precisely at higher speed that there is a higher risk of an accident if tire pressure is not sufficient. The driver should be given early warning of a loss of pressure. This speed-dependent triggering of the request for the tire pressure has the further advantage that, viewed overall, an energy store (accumulator) is charged less often and thus the lifetime of the accumulator is preserved.

Also no separate speed generator is needed. This is because the information about the speed is available in any event in the motor vehicle for ABS or the engine management system. The information is available in the motor vehicle to all electrical devices if the devices are connected to the vehicle data bus. The speed-dependent triggering of an interrogation signal can also be used with methods other than the tire pressure measuring system, in which the influence of disturbance signals, especially if these systems are widely used in vehicles, are to be reduced as much as possible.

The speed information would not have to reach each individual transceiver. A central control unit can also receive the speed information and instruct the transceivers connected to it to transmit a request signal as a function of speed. The central control unit also ensures that the transceivers of the vehicle are not activated simultaneously to send out the request signal.

Thus such a configuration can be used for a tire pressure measuring system with a passive transponder, in which an energy transmitter as well as a data receiver are each assigned to a wheel and are disposed in its vicinity on the vehicle side. A data transmitter and also an energy receiver are each disposed in a tire of the vehicle. This configuration with the two units close to one another allows the energy signals to be kept relatively small. If the triggering of the energy signals (i.e. the timing of the energy signals) is also undertaken as a function of the speed, these signals interfere with each other less frequently with functionally identical systems of other vehicles and vice versa.

The data transmitter is advantageously connected to a tire pressure sensor, a temperature sensor, a tire wear sensor or a load sensor. This allows the current tire parameters to be requested frequently enough and on deviation from reference values a visual or audible indication can be triggered for the driver.

The energy receiver features a buffer in which the transmitted energy is buffered. As soon as the transmission of the energy is completed, the energy is taken from the buffer and used to prepare and transmit data. When a load modulation is used the energy signal is also still present during the transmission of the data signal. In this case the transceiver is “loaded” by the transponder in the rhythm of the data by which the data is transmitted to the transceiver.

Any speed generator already present in the vehicle, of the ABS system for example can be used as a speed generator. The speed signals are available on the vehicle data bus (data line) to all devices connected to the bus. This allows the control unit or the transceiver with the energy transmitter to be used as a function of speed to trigger the pressure signals. An additional speed generator is thus no longer required.

The energy transmitter and also the data receiver can be embodied as a transceiver in a separate housing and the energy receiver and the data transmitter as a transponder in a separate housing or as one constructional unit in each case with a shared transmit an receive antenna respectively.

So that the energy receiver and the data transmitter do not need too much energy and are not too much of an effort to construct, both operate in the same frequency band, and therefore at around the same carrier frequency. Thus different transmission technologies, which would represent extra expense, are not needed.

The data receivers will be disturbed less if all energy transmitters in a motor vehicle transmit their energy signals at different times and the signal timing does not overlap.

Such a configuration and such a method can advantageously be used for a tire pressure measuring system in which it is advantageous in any event for the tire pressure to be frequently checked at high speed. The configuration and the method can also be used for other possible applications in which signals are to be transmitted wirelessly to a remotely sited receiver and are to trigger the return of data there. Such a configuration and such a method would also be possible for an airbag system (restraint system), since with this system too a more frequent transmission of position data of persons on the seats is desirable at high speeds.

Other features which are considered as characteristic for the invention are set forth in the appended claims.

Although the invention is illustrated and described herein as embodied in a configuration and a method for bidirectional transmission of signals in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a configuration for bidirectional transmission of signals in a motor vehicle with a tire pressure measuring system according to the invention;

FIG. 2 is a diagrammatic, cross-sectional view through a wheel of the configuration in accordance with FIG. 1;

FIG. 3 is a top plan view of the wheel of the configuration in accordance with FIG. 1;

FIG. 4 is a block diagram of a transceiver and of a passive transponder of the configuration in accordance with FIG. 1; and

FIGS. 5A to 5D are intensity graphs over time of the transmitted signals.

### DESCRIPTION OF THE PREFERRED EMBODIMENTS

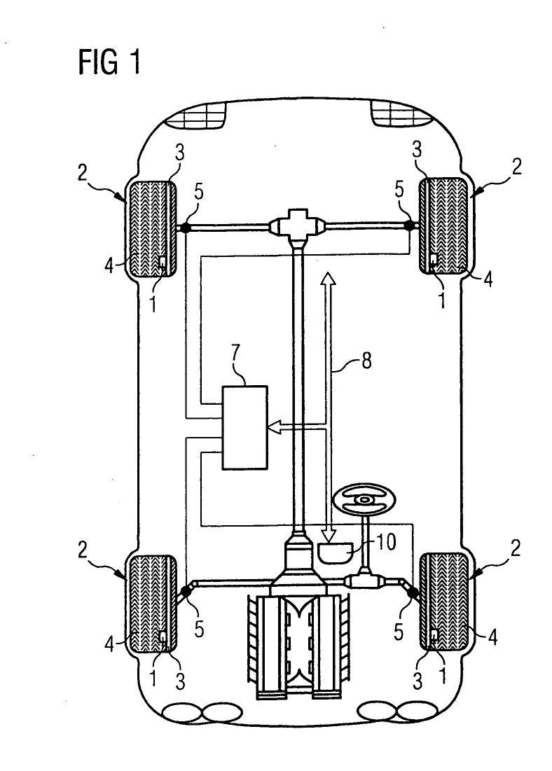

Referring now to the figures of the drawing in detail and first, particularly, to FIG. 1 thereof, there is shown a configuration and a method for bidirectional transmission of signals between two transceiver units disposed remotely from one another in the motor vehicle and is explained below using a tire pressure measuring system as an exemplary embodiment. In this case a transceiver is used to transmit energy to a passive transponder, which triggers the return of tire data from the transponder to the transceiver.

A “transponder” here is taken to mean an electrical device which can both receive and transmit signals. Various information data is modulated onto the transmitted signal in this case. Such information can be measured values or also other physical parameters such as tire pressure, temperature, revolutions, accelerations, tire wear, loading, etc. Fixed information can also be modulated onto the signal, such as for example a tire identification code. With transponders a distinction is made between passive transponders and active transponders. Passive transponders need energy that is sent to them by a transceiver. Such a transceiver can also be designated as an interrogation device. Active transponders do not need an external power source but have their own power source, for example a battery or a rechargeable cell. Active transponders remain in the sleep or stand-by mode until they are woken up by a request or interrogation signal of a transceiver. Passive transponders on the other hand automatically return their signal as soon as enough energy has been received from the transceiver (energy signals can still be present) or as soon as the energy transmission is ended (i.e. the energy signals are no longer present and the transmission channel is “free”).

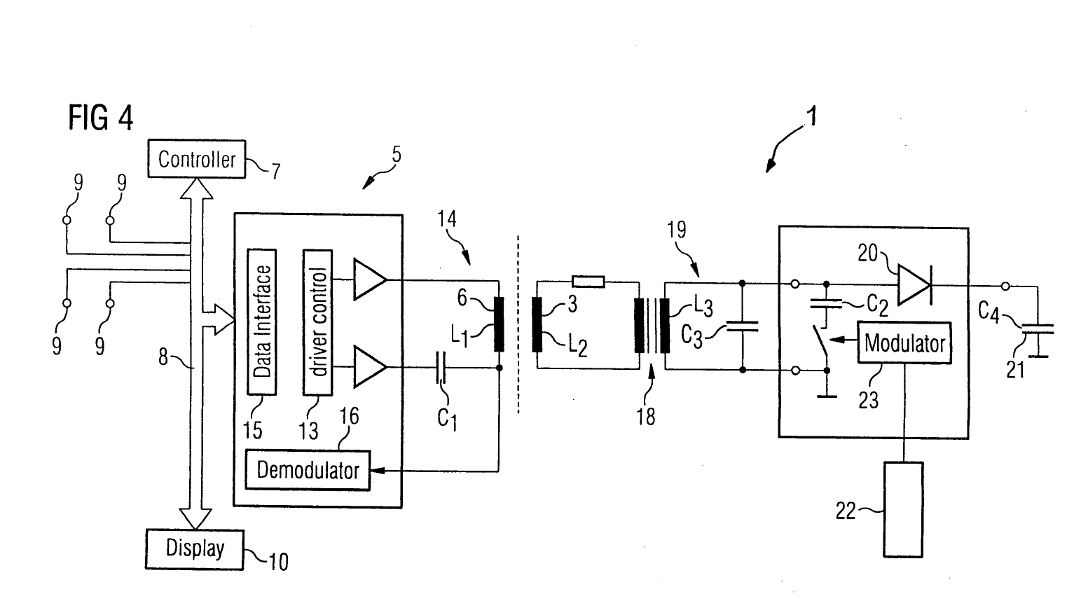

In the present exemplary embodiment as shown in FIG. 1 a passive transponder 1 is disposed in each wheel 2. It features an antenna 3 disposed axially to the axle of the vehicle, the antenna 3 being advantageously disposed on the side wall of the tire 4. The antenna 3 is inductively or magnetically coupled to the actual transponder 1 (the transponder 1 is illustrated in greater detail in FIG. 4). Each wheel position, front left and right as well as rear left and right, is assigned at least one transceiver 5. The spatial assignment can be undertaken by disposing an antenna 6 of the transceiver 5 in the vicinity of each wheel 2 or by locating the complete transceiver 5 there.

The transceiver 5 is linked to a control unit 7 which in turn is connected to a data line 8 (for example the vehicle bus). Many other devices, such as a wheel speed generator (see FIG. 4) as a speed generator 9 for an antilock braking system (ABS), an engine management unit or a display 10, are also connected to the vehicle bus 8.

If the transceivers 5 are disposed in the immediate vicinity of the wheels 2 they can be connected via the vehicle bus 8 to the common control unit 7. With the invention it is advantageous to dispose the antennas 6 of the transceiver 5 close to the antennas 3 of the transponders 1 so that fields transmitted by the transceiver 5 will also actually be received by the transponders 1. The closer the two units are to each other and the better the electromagnetic coupling is, the lower the field strengths of the transceiver 5 and also of the transponder 1 can be set and still allow energy and data to be safely received. The advantage of this is that there is less disturbance to other receivers further away.

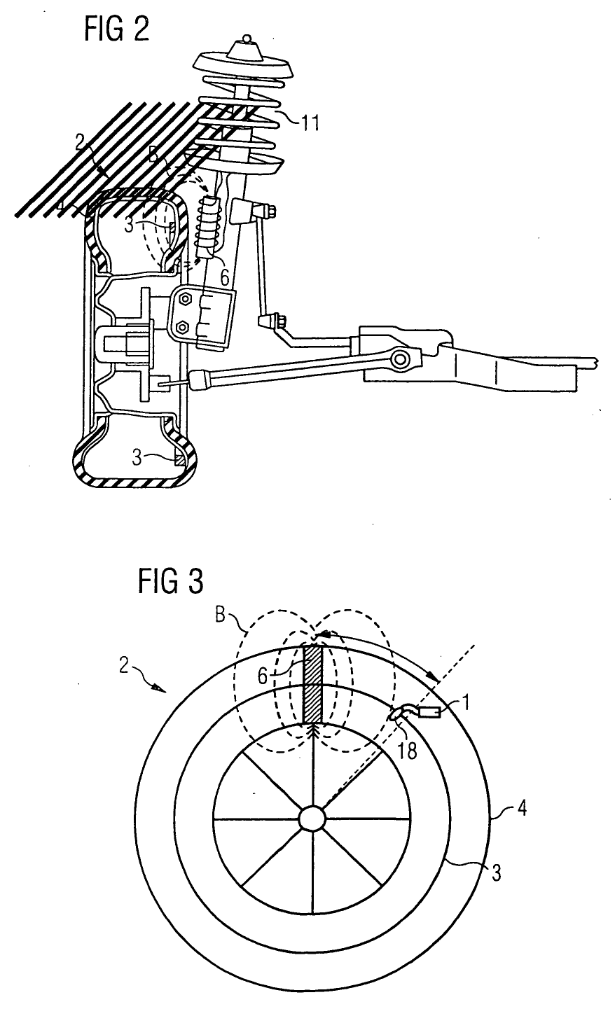

This exemplary embodiment involves an inductive system for transmission of energy and data, in which the transceiver 5 and the transponder 1 respectively each use a common transmit and receive antenna 3, 6, each of which is embodied as a coil. The transmit and receive antenna 6 of the transceiver 5 is disposed close to a wheel 2 in each case and as close as possible to the antenna 3 of the transponder 1 (FIG. 2). The antenna 6 of the transceiver 5 is aligned such that its magnetic field B is effective with sufficient strength in the area of the antenna 3 of the transponder 1 in the tire 4 (good magnetic coupling), when alternating current flows through the coil. When the magnetic field generated by a coil intersects with the coil surface(s) of the other coil with sufficient density there is good coupling and thereby good signal transmission.

In FIG. 2 the antenna 6 of the transceiver 5 is disposed as a coil with a ferrite core on a damper 11. The antenna 3 of the transponder 1 is disposed as a ring coil axially (with the wheel axle as its center axis) on the circumference and on the inner side wall of the tire 4 (FIGS. 2 and 3). Where possible no metallic parts should be disposed between the two antennas 3, 6, so that the transmission of signals is not shielded or attenuated. Thus the antenna 3 should not be mounted on the rim of the wheel 2, since the rim is normally made of metal and would interfere with the signals. If the antenna 6 of the transceiver 5 is disposed at the height of the antenna 3 of the transponder 1 as well as in its vicinity and roughly at right angles to it, the magnetic fluxes of the two coils are well coupled to each other, so that signals can be transmitted back and forth.

For transmission of energy (and also data where necessary) the transceiver 5 features an initial driver stage 13 (FIG. 4) that excites an LC oscillating circuit 14 with a coil L₁ (antenna coil) and a capacitor C₁ with an oscillation. To control the transmission, the transceiver 5 is controlled via an interface 15 from the control unit 7.

The LC oscillating circuit 14 is also employed to receive data, with the received, induced oscillation (magnetic coupling into the coil L₁) being tapped via a demodulator 16 (demodulated) and the data contained within it being directed via the interface 15 to the control unit 7 for analysis.

The transponder 1 features the ring coil as the antenna 3 (identical with coil L₂ in FIG. 4), which is disposed axially in the tire 4. A low or high frequency magnetic field generated by the LC oscillating circuit 14 of the transceiver 5 induces with good magnetic coupling an oscillation in the antenna circuit of the transponder 1. The oscillation is routed via a matching transformer 18 to the actual transponder 1 with a parallel LC oscillating circuit 19 with a coil L₃ (part of the matching transformer 18) and a capacitor C₃. The coil L₃ is threaded (coupled) into the antenna 3 in accordance with FIG. 3. Thus—regardless of the wheel angle setting (see dotted line and arrow in FIG. 3) of the transponder 1—the transponder 1 is always inductively coupled to the transceiver 5, since the magnetic field B is always coupled to the antenna 3.

The transponder 1 features a rectifier 20 via which the received oscillation is rectified in order to charge up an energy store 21 (here for example a charge capacitor C₄). The energy store 21 is used to supply the elements of the transponder 1 with energy in order to transmit data back to the transceiver 5. As soon as the charging up of the energy store 21 is completed (synonymous with the end of the energy signal from transceiver 5), the preparation and transmission of data begins. The duration of the energy signal is dimensioned such that the energy store 21 is sure to be charged up enough to provide sufficient energy to supply the components of the transponder 1.

The data to be sent can be measured physical variables or fixed data that is stored in the transponder 1. Thus the transponder 1 can be linked to one or more sensors 22, such as a pressure sensor, temperature sensor, load sensor, tire wear sensor, acceleration sensor etc. The measured values are routed as digitally edited data to a modulator 23 which ensures that the data is modulated onto a carrier oscillation of the LC oscillating circuit 19 of the transponder 1. The modulated oscillation is transmitted via the matching transformer 18 to the antenna 3 of the transponder 1.

If there is good magnetic coupling between the antenna 3 of the transponder 1 and the antenna 6 of the transceiver 5, the modulated oscillation is transmitted as a low-frequency magnetic field B to the transceiver 5. The LC oscillating circuit 14 of the transceiver 5 then oscillates at the modulated oscillation. The data can now be demodulated from the oscillation.

In this way the data is transmitted to the transceiver 5. There the data is demodulated and routed to the control unit 7. Depending on requirements the data can then be used to control a visual or audible indication or to control other functions in the motor vehicle.

Energy and data are transmitted in a single channel in this case, i.e. at around the same carrier frequencies both from the transceiver 5 to the transponder 1 and from the transponder 1 back to the transceiver with an inductive transmission at 125 kHz which is advantageously used as a carrier frequency. The frequency band from 119 to 135 kHz may be used in Germany without a license with higher signal strengths (here for example for the energy signal). With low signal strengths (here for example the data signal) a wider range may be used than for high signal strengths, so that, if required, the frequency range for sending back the data can be departed from. The transmitters 1, 5 and receivers 1, 5 with their LC oscillating circuits 14, 19 are tuned to this frequency range in this case.

With inductive transmission, transmit and receive circuits are each tuned to the resonant frequency of the other circuit (with ASK=Amplitude Shift Keying the carrier frequencies are about the same and with FSK=frequency Shift Keying the carrier frequency and thereby resonant frequency is approximately midway between the two modulation frequencies). As a result of component tolerances there can however be slight deviations, so that the signals can be received more or less well within the overall frequency band of the transmission channel. Thus magnetic interference fields, which might feature the same carrier frequencies, can lead to the falsifications and faults within the transmission channel and—depending on the strength of the interference—outside the frequency band as well.

So that sufficient energy is provided for the transponder 1 the field strength of the energy signals is sufficiently high. With such signals with high energy it is desirable for EMC and other disturbance reasons for these signals to only be present for as long as is absolutely necessary. The range of the inductive signals falls sharply as the distance to the transmitter increases. At the site of the energy receiver a sufficiently high energy and field strength must be present to enable the energy store 21 to also be charged up effectively. As a result of the high energy which is necessary to charge the energy store, other receivers further away in the same transmission can be disturbed by the energy signals, especially if these receivers have very high receive sensitivity, i.e. are basically structured so that they can already detect the smallest field strengths.

Only relatively little energy is available for the data signals in the present exemplary embodiment. The data signals thus only have a low field strength. This additionally has the advantage that the data signal does not disturb or only slightly disturbs signals further away. So that these signals can also be received, the receive sensitivity of the data receivers must be very high. For these reasons the data receivers are also sensitive to external disturbance signals or energy transmitters further away if the signals from other transmitters still have sufficiently high amplitudes and are generated at the same time as the data signals at the location of the data receiver.

It can thus occur that the energy signals transmitted by a transceiver 5 interfere with the receivers of other transceivers further away, so that these cannot receive or not correctly receive the data signal of the corresponding transponder assigned to them.

So that energy signals transmitted to each wheel 2 do not disturb the other data receivers 5 within the same motor vehicle, it is advantageous for each of the transceivers assigned to a wheel 2 to transmit the energy signal during a separate time window so that the time windows of the different energy signals do not overlap.

If other vehicles use functionally identical systems which operate in the same transmission channel, faults can arise, especially when traffic is heavy, which are caused by vehicles close by and their energy signals, since the energy signals can still exhibit a field strength of the order of magnitude of the data signal and thus disturb the data signal just interrogated by signal overlay.

With tire pressure measuring systems it is usual for the tire pressure to be measured intermittently at regular or irregular intervals (interrogated by control unit 7). Conventionally the pressure is measured at a fixed repetition rate while the vehicle is on the move whereas it is only measured at a low repetition rate or not at all when the vehicle is stationary. So that one's own vehicle with its tire pressure measuring system suffers hardly any interference from other vehicles in the receipt of data signals, there is provision in accordance with the invention for the energy signals to be triggered more frequently or less frequently depending on the speed of the vehicle.

Thus the repetition rate is increased at high speed—depending on the speed of the vehicle—and decreased at low speeds. Since, when the vehicle is traveling at high speed there are likely to be fewer other vehicles in the immediate vicinity (if safety margins are observed), fewer electromagnetic disturbance signals from other vehicles can also have an effect on the reception of data signals. If in these vehicles identical systems are used for transmission of energy and data that operate in the same transmission channel, the likelihood is then less that interference signals from the other transmitters will overlay the data signals.

At slow speed, especially during traffic congestion, it is far more likely that vehicles with identical transmission system are in the vicinity, which could then disturb the transmission of data. Thus, if data is interrogated relatively infrequently at low speed, the faults are also fewer since the time windows in which the energy signals are sent are statically distributed over a longer period.

For tire pressure measuring systems this has the advantage of not restricting safety, since at high speed the tire pressure should be interrogated more frequently than at lower speed. This is because at high speed the driver has to be notified more quickly that the tire pressure is too low, since the danger of an accident is much greater then. When the vehicle is stationary or traveling slowly a relatively infrequent request for the tire pressure is all that is required. This is because the danger of an accident as a result of inadequate tire pressure is very low. The rate of repetition of the tire pressure interrogations is then increased ever more as speed increases, without more interference being received from other interference sources, since at the same time the likelihood of outside interference sources in the vicinity decreases.

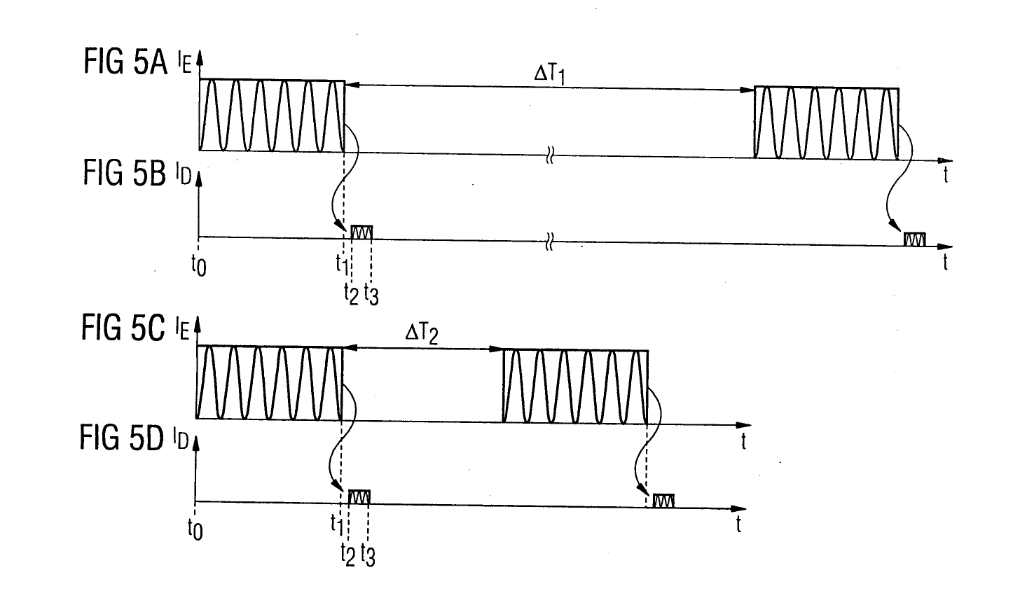

In FIGS. 5A to 5D the signals transmitted over time are shown at both low speed of the vehicle (in FIG. 5A the energy signals and in FIG. 5B the data signals) as well as at high speed (in FIG. 5C the energy signals and in FIG. 5D the data signals). The duration of the energy signal (energy oscillation) is around 2.5 s (time between points t₀ and t₁) for a charge process of the energy store 21 of the transponder 1 in the tire 4. The duration of the energy signal is thus always the same, regardless of the speed. Only the rate of repetition of the transmission of the energy signals is changed as a function of speed.

To this end a transmission pause ΔT₁ between the energy signals is controlled as a function of the vehicle speed, with energy signals being transmitted less frequently at lower speed than at higher speed. The transmission pauses ΔT₁ between the energy signals can conversely be changed in proportion and linearly/constantly to the speed of the vehicle or also by stages or in steps.

FIG. 5B shows the response signal/data signal of the transponder 1, which is triggered automatically in response to the transmission of the energy by the transponder 1 and returned to the transceiver 5. The data signals should only be present for a short time and with sufficient intensity for the data receiver not to have to remain switched on for too long. Thus only a period necessary for the information or the data to be fully and securely transmitted is sufficient.

With a tire pressure measuring system this period can for example be around 20 ms (time between points t₂ and t₃), and can be independent of the speed of the vehicle. High field strengths cannot usually be implemented for the data signals since the energy store 21 is limited in its capacity to accept energy.

FIGS. 5A to 5D do not specify absolute values for the field strengths I_{E} (field strength or intensity of the energy signals) and I_{D} (field strength or intensity of the data signals) of the signals but only show the variable relationships schematically. Thus the field strengths I_{E}, I_{D} can be the field strengths I_{E}, I_{D} at the receive location or the transmit location. Since the fields weaken as regards their field strengths I_{E}, I_{D} equally with increasing distance, their relationships to each other remain the same.

In the present exemplary embodiment of a tire pressure measuring system an energy signal is transmitted at low vehicle speed between times t₀ and t₁ (FIG. 5A). After the energy signal ends the data signal is generated automatically and returned between the times t₂ and t₃ (FIG. 5B).

At high speeds (FIGS. 5C and 5D) the transmit pause ΔT₂ between the energy signals is shorter than the transmit pause ΔT₁ at low speeds, i.e. the tire pressures are interrogated more often. The period for which the signal is present remains the same however.

A staged change in the interrogation repetition rate is assumed below. Thus, at low speed (0 to 30 km/h) the transmit pause ΔT₁ between two energy oscillations can for example amount to around 120 seconds at 2.5 s duration of the energy oscillation. At a speed of 30 to 60 km/h the transmit pause ΔT₂ can amount to around 60 seconds, at 60 to 100 km/h around 20 seconds and above 100 km/h around 10 seconds.

In accordance with the invention the triggering of the energy signals of each transceiver 5 is controlled as a function of speed with a repetition rate proportional to the speed.

It is advantageous if a speed generator 9 that is present in any event, for example the one used by an ABS system, is used for which the speed signal is transmitted over the vehicle bus to the ABS control unit. Since the control unit 7 for the tire pressure measuring system is also connected to the vehicle bus it has access to the speed signal. Depending on the speed of the vehicle each transceiver 5 can the be correspondingly instructed to transmit energy signals.

Naturally separate speed generators 9 can also be used which control the triggering of the energy signals as a function of the speed of the vehicle.

Instead of assigning the transceivers 5 directly to the wheels 2 and arranging them in the vicinity of the latter, it is sufficient for just the antennas 6 to be disposed in the vicinity of the wheels 2. A central transceiver 5 can then be present which controls the individual antennas 6 in sequence and not overlapping. In the vehicle the energy signals should not be transmitted at the same time as the data signals. The times and durations of the transmission of the data signals is known since they are automatically returned a short time after the end of the energy signals.

However the antennas 6 and transceivers 5 can also each be disposed in the vicinity of the wheel 2, in which case the central control unit 7 can then be present. The control unit 7 can also be contained in each transceiver 5. The signals in this case can be transmitted in the HF or also in the LF frequency range in the same transmission channel. The modulation used is not significant for the invention since all types of modulation can be used depending on requirement and opportunity.

A transmission channel in this case means a reserved, contiguous frequency range (frequency band) for transmitting information between transmitter and receiver. A transmission channel is identified by its bandwidth and its frequency position, i.e. by the position of an average frequency (e.g. of a carrier frequency) in the wavelength used. Thus for the inductive transmission of energy the frequency band from 119 to 135 kHz (bandwidth 16 kHz) at an average frequency of 125 kHz can be permitted. In almost all countries of the world different frequency bands for the wireless transmission of signals are allowed by the postal authorities. When the intensities are very small (as is the case with the data signal), the frequency band limits can be slightly exceeded, especially at 125 kHz (e.g. with a FSK one modulation frequency can lie between 108 and 119 kHz and the other modulation frequency between 124 and 135 kHz). The actual frequencies depend in any event on the environmental conditions, such as temperature. The receivers are however certainly in a position to receive signals at least within the frequency band and also slightly beyond it.

The problem of mutual interference between data receivers by powerful energy transmitters only arises when the powerful signals are sent in the same frequency band in which data signals with lower field strengths are received. If the energy signals are transmitted more often at higher vehicle speeds it is likely that fewer vehicles are within the range of the powerful signals. Thus the interrogation rate of the transponder 1 can be easily increased at high speed without any increase in faults.

A configuration in accordance with the invention for bidirectional transmission of signals in a motor vehicle and a method of this type can also be used for other applications. A speed-dependent transmission of high-energy signals could for example also be used for an airbag system. This is because outside interference sources would have only very little effect on functionality. It is thus advantageous here too for data to be transmitted more frequently at high speed and less frequently at low speed. These systems are also relevant to safety. Interference from external sources should thus be greatly reduced in any event. In any event it is advantageous for the position of the person on the seat to be interrogated more often at high speed for example without the danger of the system being strongly adversely affected by interference signals from other vehicles. This would also make an airbag system safer and the risk of mutual influence by other vehicles would still remain small.

The data signals also contain energy, but this is much smaller than the energy which is contained in the energy signals For this reason the signals with higher field strength or energy are designated as energy signals and the signals with low energy as data signals, regardless of which information or data is contained in the relevant signals. With the energy signals it is sufficient to transmit the signals as sine wave signals without information, i.e. without modulation. If status information is needed from one part (here for example the tire 4) it is usual to modulate data onto the carrier frequency, the data then being recovered in the transceiver 5 by demodulation. To do this however it is sufficient if the energy and thereby the field strength/amplitude of the data signals is significantly lower compared to that of the energy signals.

The modulation types and the encoding of the signals are not an issue here. Advantageously in tire pressure measuring systems binary encoded data is transmitted with an FSK modulation. Transmission with what is known as load modulation (a load such as the capacitor C₂, is switched in parallel to the LC oscillating circuit 19 and its resonant frequency thus modified) is also very advantageous. With load modulation the data from transponder 1 is inductively impressed into the LC oscillating circuit 14. Thus in this case the energy oscillation is also retained during the return of the data. The demodulator 16 removes the data from the oscillation and forwards it to the control unit 7.

The configuration in accordance with the invention and the method can be used at any location in the motor vehicle where bidirectional signals are transmitted and external transmit signals could be present at the same time as the desired receive signals.

Since high-energy signals interfere more often, it is important that in these situations (slow speed or vehicle stationary) in which more interference sources are likely to be present, for energy signals to be transmitted less often and in situations (fast movement), in which fewer interference sources are likely to be in the immediate vicinity, for energy signals to be transmitted more often, compared to a conventional system in which the energy signals are transmitted with a constant repetition rate.

This application claims the priority, under 35 U.S.C. § 119, of German patent application No. 10 2004 004 292.6, filed Jan. 28, 2004; the entire disclosure of the prior application is herewith incorporated by reference.

1. A configuration for bidirectional and wireless transmission of signals in a motor vehicle, the configuration comprising:
a control unit;
a first transmitter which, when triggered by said control unit, transmits a request signal;
a first receiver disposed remotely from said first transmitter, which, as a result of receipt of the request signal initiates preparation and transmission of a response signal;
a second transmitter connected to said first receiver and transmits the response signal;
a second receiver disposed remotely from said second transmitter and receives the response signal and forwards the response signal to said control unit for evaluation;
a data line connected to said control unit;
a speed generator coupled via said data line to said control unit, a triggering of the request signal being a function of speed of the motor vehicle and the request signal being triggered more frequently at high speeds than at low speeds;
said first transmitter being an energy transmitter, and on triggering transmits energy in an energy signal and said second receiver being a data receiver, said energy transmitter with said data receiver forming a transceiver assigned to a wheel in each case; and
said first receiver disposed remotely from said transceiver and said second transmitter connected to said first receiver forming a transponder having an energy store for buffering the energy received, said transponder disposed in a tire of the motor vehicle in each case.

2. The configuration according to claim 1, further comprising at least one sensor selected from the group consisting of tire pressure sensors, temperature sensors, and load sensors, said sensor connected to said transponder and provides a direct measured physical variable as data to said second transmitter for transmitting the response signal.

3. The configuration according to claim 2, wherein said energy store is a capacitor for storing energy, the energy being used to transmit the response signal being a data signal and to supply said sensor connected to said transponder with energy.

4. The configuration according to claim 1, wherein said speed generator is present in the motor vehicle in any event and is connected directly or indirectly via a vehicle data bus being said data line via said control unit to said energy transmitter

5. The configuration according to claim 1, wherein said control unit is a central control unit which can be connected to each said transceiver and only said control unit is connected to said speed generator directly or via said data line.

6. A method for bidirectional transmission of signals in a motor vehicle, which comprises the steps of:
intermittently transmitting first signals, with a timing of a transmit pause between two consecutive first signals being set in dependence on vehicle speed, the first signals being at least one energy signal;
receiving the first signals and preparing data to be transmitted as second signals; and
transmitting the second signals as soon as at least one part of a first signal has been received, the second signals being data signals and the first and second signals being transmitted wirelessly in each case within a transmission channel at around same carrier frequencies.

7. The method according to claim 6, wherein transceivers are disposed in the motor vehicle and transmit at different times in each case, with a time for which the first signals of a respective transceiver are present do not overlap in time with a presence of the second signals of a transponder not located in a vicinity of the respective transceiver which is disposed in the motor vehicle.

8. The method according to claim 6, which further comprises transmitting the first signals less frequently at lower vehicle speeds than at higher vehicle speeds.

9. The method according to claim 6, which further comprises triggering transceivers, controlled by a control unit, in dependence on a speed of the motor vehicle, with the control unit only triggering one transceiver within a particular period and not overlapping with a period of activation of another transceiver simultaneously to transmitting the energy signal.

10. A tire pressure measuring system, comprising:
a control unit;
a first transmitter which, when triggered by said control unit, transmits a request signal;
a first receiver disposed remotely from said first transmitter, which, as a result of a receipt of the request signal initiates preparation and transmission of a response signal;
a second transmitter connected to said first receiver and transmits the response signal;
a second receiver disposed remotely from said second transmitter and receives the response signal and forwards the response signal to said control unit for evaluation;
a data line connected to said control unit;
a speed generator coupled via said data line to said control unit, a triggering of the request signal being a function of speed of the motor vehicle and the request signal being triggered more frequently at high speeds than at low speeds;
said first transmitter being an energy transmitter, and on triggering transmits energy in an energy signal and said second receiver being a data receiver, said energy transmitter with said data receiver forming a transceiver assigned to a wheel in each case; and
said first receiver disposed remotely from said transceiver, and said second transmitter connected to said first receiver forming a transponder having an energy store for buffering the energy received, said transponder disposed in a tire of the motor vehicle in each case.

11. A tire pressure system for a vehicle, comprising:
a transceiver assigned to a vehicle wheel and intermittently transmitting first signals, with a timing of a transmit pause between two consecutive first signals being dependent on vehicle speed, the first signals being at least one energy signal;
a transponder disposed in a tire of the vehicle and receiving the first signals and preparing data to be transmitted as second signals, said transponder transmitting the second signals as soon as at least one part of a first signal has been received, the second signals being data signals and the first and second signals being transmitted wirelessly in each case within a transmission channel at around same carrier frequencies.

12. A configuration for bidirectional and wireless transmission of signals in a motor vehicle, the configuration comprising:
a control unit;
first transmitters which, when triggered by said control unit, each transmit a request signal;
first receivers disposed remotely from said first transmitters, which, as a result of receipt of the request signal initiate preparation and transmission of a response signal;
second transmitters each connected to a respective one of said first receivers and transmit the response signal;
second receivers disposed remotely from said second transmitters and receive the response signal and forward the response signal to said control unit for evaluation;
a data line connected to said control unit;
a speed generator coupled via said data line to said control unit, a triggering of the request signal being a function of speed of the motor vehicle and the request signal being triggered more frequently at high speeds than at low speeds;
said first transmitters being energy transmitters, and on triggering transmit energy in an energy signal and said second receivers being data receivers, a respective one of said energy transmitters with a respective one of said data receivers forming a transceiver assigned to a respective wheel in each case; and
said first receivers disposed remotely from said transceiver, a respective one of said second transmitters connected to a respective one of said first receivers form a transponder having an energy store for buffering the energy received, said transponder disposed in a tire of the motor vehicle in each case.
